(19) United States
(12) Patent Application Publication
(10) Pub. No.: US 2020/0294166 A1
(43) Pub. Date: Sep. 17, 2020

(54) CALCULATING A DEGREE OF MATCH FOR A PLURALITY OF CAREER OPTIONS

(71) Applicant: International Business Machines, Armonk, NY (US)

(72) Inventors: Etienne Eben Vos, Johannesburg (ZA); Matokollo Magadla, Tembisa (ZA); Mathibele Willy Nchabeleng, Centurion (ZA)

(21) Appl. No.: 16/353,794

(22) Filed: Mar. 14, 2019

(51) Int. Cl. G06Q 50/20; G06N 5/02

(52) U.S. Cl. CPC G06Q 50/205; G06N 5/02

(57) ABSTRACT

A computer-implemented method provides career options and comprising classifying, by an academic classification module, each of a plurality of academic subjects into a plurality of topics and classifying, by a career classification module, each of a plurality of career options as comprising a plurality of topics. The method comprises determining, by a grading module, for a student, a grade associated with each topic for each subject and calculating, by a prediction module, a degree of match for each career option for the student, the degree of match based on each topic which comprises the career option weighted according to the grade associated therewith.

### BACKGROUND

The present invention relates to a computer-implemented method and a computer system for providing career options, and specifically for calculating a degree of match for a plurality of career options.

### SUMMARY

According to an example embodiment of the present invention, a computer-implemented method for providing career options, the method comprising classifying, by an academic classification module, each of a plurality of academic subjects into a plurality of topics and classifying, by a career classification module, each of a plurality of career options as comprising a plurality of topics. The method comprises determining, by a grading module, for a student, a grade associated with each topic for each subject and calculating, by a prediction module, a degree of match for each career option for the student, the degree of match based on each topic which comprises the career option weighted according to the grade associated therewith.

Example embodiments of the present invention extend to a corresponding computer and computer program product.

### BRIEF DESCRIPTION OF THE DRAWINGS

FIG. 1 illustrates a schematic diagram of a computer system for providing career options, in accordance with an example embodiment;

FIG. 2 illustrates a flow diagram of a method for providing career options, in accordance with an example embodiment;

FIGS. 3-6 illustrate example classifications of subjects into topics according to the computer system and method of FIGS. 1-2.

FIG. 7 illustrates a school curriculum classified according to the computer system and method of FIGS. 1-2.

FIG. 8 illustrates career options classified according to the computer system and method of FIGS. 1-2.

FIG. 9 illustrates a flow diagram 900 of a grading data collection approach according to the computer system and method of FIGS. 1-2.

FIG. 10 illustrates a schematic view of a database of FIG. 1 in more detail;

FIG. 11 illustrates a flow diagram of a method which may be added to the method of FIG. 2.

FIG. 12 illustrates schematically information which may be contained in the database of FIG. 10.

FIG. 13 illustrates a network topology comprising the computer system of FIG. 1.

FIG. 14 illustrates a functional diagram of a self-correcting reinforcement-learning approach according to the computer system and method of FIGS. 1-2.

### DETAILED DESCRIPTION

In schools (e.g., high schools), students or students face a daunting task of deciding on an appropriate career. This may involve selecting a combination of major subjects when they transition to senior phase, and subsequently evaluating whether or not their skills are sufficient to pursue a particular career of interest or deciding which of their interests should become their career. In reality, there are many factors that determine a person's compatibility with a specific career, prominent factors being skills, interests, personality, location, network and one's abilities in general.

High school curriculums may be designed to give students a broad knowledge base in preparation for any possible career. Subjects at school therefore combine introductory content across a range of different specialized fields and may therefore be made up out of related but distinctly disjointed “topics”. It is common that students' interests and abilities gravitate towards these topics—for example, many students prefer geometry instead of algebra, or vice versa. When it comes to physics, some students might like the topics of electricity, magnetism and building circuits since they find it intuitive, but struggle to understand thermodynamics and equations of motion, and therefore prefer the one over the other. This preference of one topic over another may be related to skill or interest or a combination of both.

It may therefore be advantageous to consider academic performance data at a level of granularity where people's interests manifest, namely at topics instead of subjects (even though the latter could also suffice in some cases). Existing systems and methods evaluate a student's skills by considering academic performance data at subject level and report on a student's competency in mathematics or English as a whole, without individually considering the different disjoint sub-fields at which students' interests are focused. In the end, when a student enrolls in university or enters the job market, occupations generally require expertise in only a couple of specific topics, along with general background in others. For example, an electrician extensively uses his/her experience and knowledge in circuitry, electricity and electric theory, and some general knowledge in trigonometry, vectors, English, etc.

In many cases, when choosing a career, students would base their choice only on personal interests without considering their key strengths and the skills or topics they excel in, hence the need for career recommender systems. The challenge still remains to obtain not only some measure of these skills, but also to determine what exactly these “skills” should be and should reflect—i.e. some measure of a student's individual skills in geometry, algebra, calculus and trigonometry individually conveys more information than the same student's skill in mathematics as a whole.

Students are unlikely to keep record of their performance and progress at the level of these topics, resulting in valuable information being lost when aggregating marks achieved for different topics into subject grades, regardless of fine data-granularity that exists across time. Even though academic performance data can be evaluated at a high time-resolution, it may be useful to evaluate academic performance at a suitable content-resolution as well. This would assist in choosing and committing to a career that best aligns with one's interests, skills and capabilities, instead of choosing a career (mostly haphazardly) only based on one's interest and/or final subject grades, which may result in undesired career detours.

An example embodiment of the present invention proposes to use a student's capability in topic-based skills, measured from academic performance data at the level/granularity of topics, for the purpose of providing career recommendations, advice and guidance throughout school. This approach may capture a more accurate representation of a student's interests and skills.

In this specification, the term “student” is used and may comprise a learner, a pupil, a person at a school or college or a home school, etc. The term “career” may comprise any career path, occupation, vocation, or skilled trade. The term “test” may refer to various types of tests, including class tests, written or oral papers, exams, quizzes, etc.

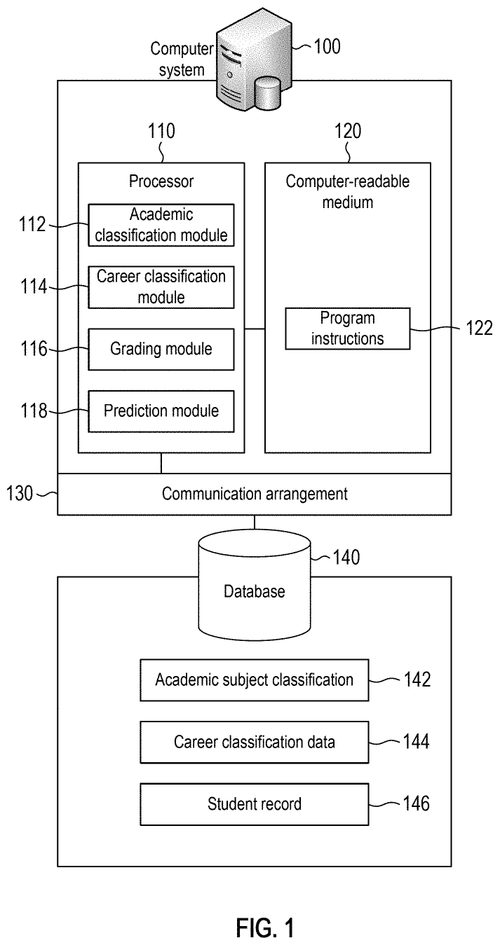

Accordingly, a computer system 100 (FIG. 1) in accordance with an example embodiment of the invention may provide recommendations, advice and guidance to a student using a novel approach whereby emphasis is placed on topic-based skills. This is realized, at least in part, by classifying or provisioning various subjects into “topics”. The concept of topic-based skills refers to a student's aptitude/competency in different topics that make up a single subject at school. A very broad subject like mathematics, for example, consists of related but distinctly disjoint topics like algebra, calculus, geometry, trigonometry, word problems, etc.

The computer system 100 may be configured to determine a student's competency in all of such topic-based skills using appropriate high-resolution/fine granularity academic performance data.

FIG. 1 illustrates the computer system 100 for providing career options. More specifically, the computer system 100 is configured to calculate a degree of match for a plurality of career options. The computer system 100 comprises a computer processor 110 communicatively coupled to a computer-readable medium 120. The computer processor 110 may be one or more microprocessors, controllers, or any other suitable computing resource, hardware, software, or embedded logic. Program instructions 122 are stored on the computer-readable medium 120 and are configured to direct the operation of the processor 110. The processor 110 (under the direction of the program instructions 122) comprises a plurality of conceptual modules 112-118 which may correspond to functional tasks performed by the processor 110.

The computer system 100 has a communication interface 130 for communication with other components and/or communication via a telecommunications network (e.g., the internet).

The computer system 100 may also comprise a database 140 (or other form of data storage) coupled thereto. The database 140 has stored thereon academic subject classification data 142, career classification data 144, and a plurality of student records 146 (only one of which is illustrated). The student record 146 comprises various parts or sections of data (as described further below). The entire computer system 100, including the database 140, may be cloud-hosted or provided as a SaaS (Software as a Service). Although the database 140 is indicated as a single database, it may comprise plural databases networked together. For example, the career classification data 144 may reside on a first database and the student records 146 may reside on a second database.

The modules 112-118 are configured to perform various functions associated with the computer system 100. Although the functionality is described in more details with reference to method flow diagrams below, briefly, the modules 112-118 are as follows:
Academic classification module 112: classifies or provides a classification of a plurality of academic subjects into a plurality of topics.
Career classification module 114: classifies or provides a classification of a plurality of career options as comprising a plurality of topics.
Grading module 116: determines grades and various other metrics associated with subjects and topics of a student.
Prediction module 118: calculates a degree of match for various career options for the student, the degree of match being topic-based which comprises the career option weighted according to the grade associated therewith.

The computer system 100 is thus configured to provide career recommendations, advice and guidance by comparing and matching a student's competency across all topic-based skills to a database of all careers and their associated topic-based skills required for success. This may provide a finer granularity than existing careers recommendation platforms which may be more broadly subject-based (as opposed to topic-based).

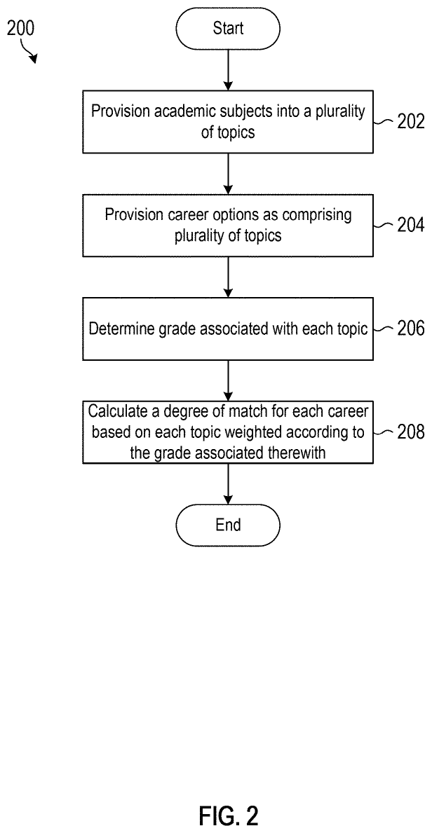

FIG. 2 illustrated a flow diagram 200 of a computer-implemented method 200 for providing career options in accordance with an example embodiment of the invention. Although in this description the computer system 100 implements the method 200, it should be appreciated that the computer system 100 may be configured to implement a different method and that the method 200 may be implemented by different systems.

Academic subjects are classified or provisioned (at block 202) into a plurality of topics. This provisioning process is implemented by the academic classification module 112. The subjects themselves may be traditional academic subjects like English (and/or other languages), Science, Geography, Mathematics (math or maths for short), etc.

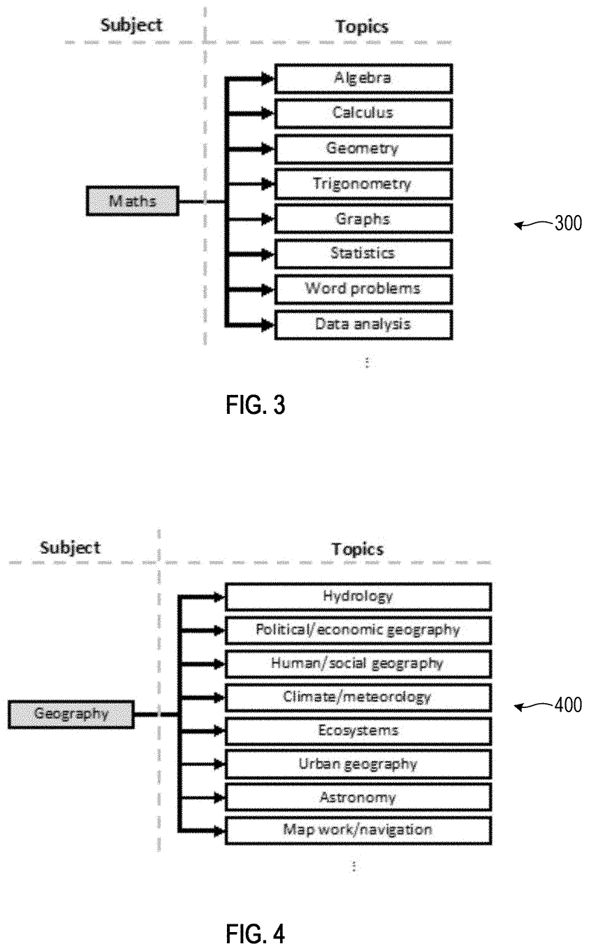

FIGS. 3-6 show various subjects divided into respective pluralities of topics 300-600.

There are various ways in which the subjects may be provisioned or divided into topics. A particular subject may be manually classified into topics by an administrator and this classification saved into the database 140 as academic subject classification data 142. In such case, the academic classification module 112 may be configured to provision a subject (e.g., Math) into topics (e.g., Algebra, Calculus, etc.) by interrogating the academic subject classification data 142 in the database 140 and applying it to given academic subjects. In alternative embodiments, the academic classification module 112 may be supplied with classification algorithms and may then be configured to apply the algorithms to given academic subjects to classify them automatically into topics. Either way, the academic classification module 112 provides or provisions a plurality of topics respectively for a plurality of subjects.

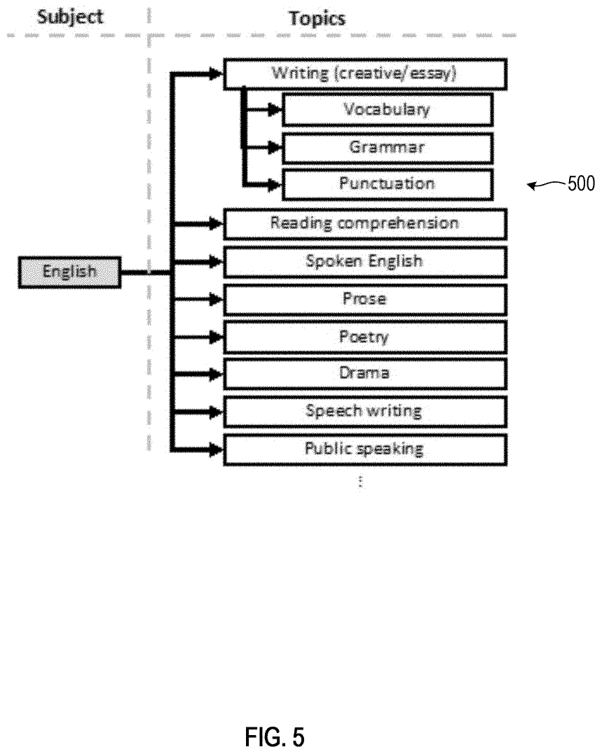

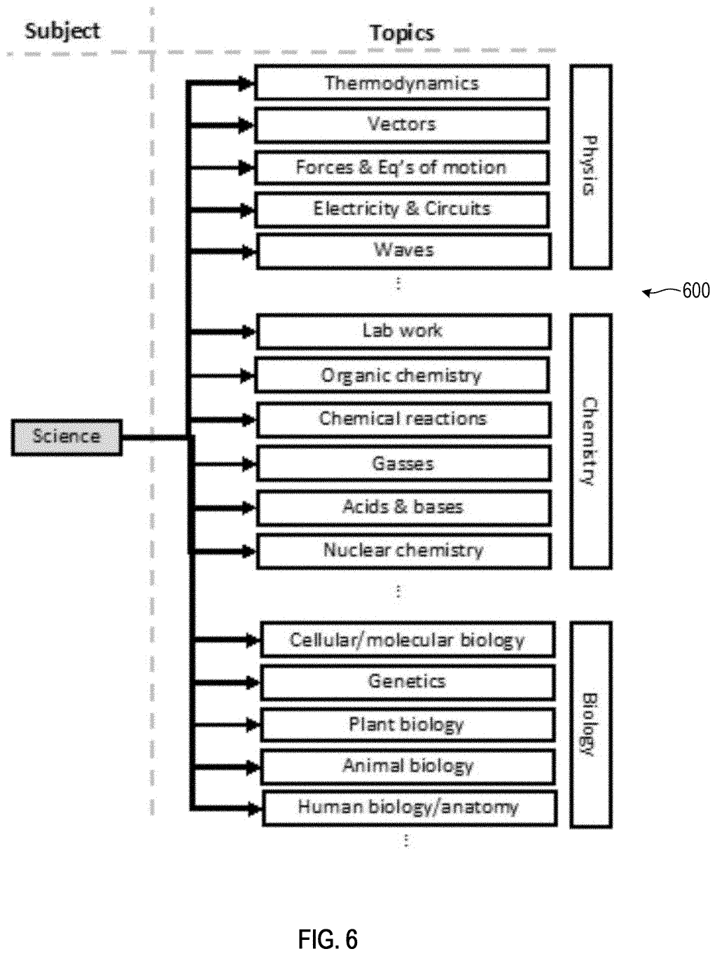

Vary topic classification structures may be provided. For example, in FIGS. 3-4, simple one-level structures of topics 300, 400 are illustrated, in which each subject includes only a plurality of individual topics. However, the topic classification process may be configured to provide other structures. In FIG. 5, one of the topics (Writing) has been further classified into sub-topics (Vocabulary, Grammar, and Punctuation). This may provide for further granularity of the topic classification process. In FIG. 6, the topics have been grouped together into three associated groups ((Physics, Chemistry, Biology). This may provide for further granularity or structure of the topics.

This process of reducing a subject into topics may be done only once (e.g., when initiating the computer system 100) or may be an on-going or iterative process in which the classification is updated or tweaked continually.

Accordingly, a novel aspect of the example embodiment may be the nature and granularity of the subjects. Subject at school normally consists of collections of related but distinctively disjoint topics. These topics, in accordance with the example embodiment, may be considered coherent groupings of information that make up the content of a subject and are evident from the chapter, unit and section-wise divisions that exist in any school textbook across all subjects. It is also prevalent that students' interests, skills and abilities tend to gravitate toward these topics. A student might, for example, find geometry and trigonometry interesting and more intuitive than algebra and calculus, or might do very well in the topic of electricity and electric circuits but not so well in thermodynamics and waves.

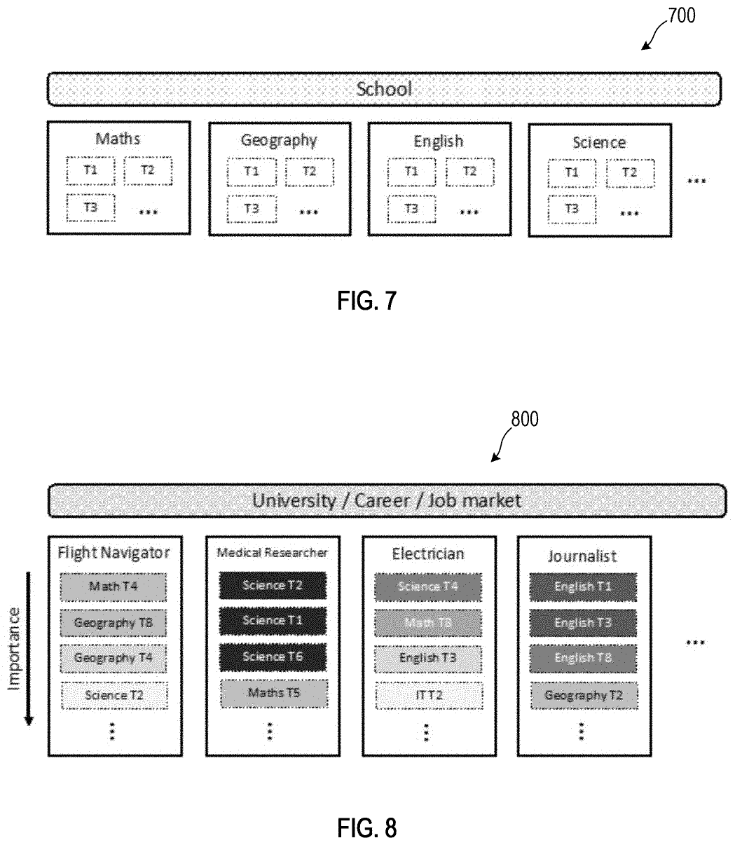

There may therefore be a strong connection between a person's interests, skills and abilities and the topics that make up a subject. Therefore, a notion of topic-based skills is introduced, which serves as a measure/gauge of a student's competence in these topics, rather than competence in a subject as a whole. Accordingly, using this new classification, a school curriculum may resemble chart 700 illustrated in FIG. 7.

Following on from this, various careers are also provisioned or classified (at step 204) as comprising a plurality of topics, instead of merely comprising a number of broad-level subjects. Each topic which comprises a career may be weighted or have a significance weighting associated therewith, such that topics with a higher significance weighting may be more important in the specific career than topics with a lower weighting.

Once again, there are various ways in which a particular career may be provisioned or divided into various topics. A particular career may be manually classified into topics by an administrator and this classification saved into the database 140 as career classification data 144. In such case, the career classification module 114 may be configured to provision a career (e.g., Flight Navigator) into topics by interrogating the career classification data 144 in the database 140 and applying it to given careers. In alternative embodiments, the career classification module 114 may be supplied with classification algorithms and may be then be configured to apply the algorithms to given careers to classify them automatically into topics and weight those topics. Either way, the career classification module 112 provides or provisions a plurality of topics respectively for a plurality of careers.

FIG. 8 illustrates a chart 800 of various traditional careers classified into a plurality of academic topics. For example, the career “Flight Navigator” which is illustrated in column one of the chart 800 may comprise Math Topic 4 (T4), e.g., trigonometry, Geography Topic 8 (T8), e.g., map work/navigation, and so forth. A career may comprise plural topics from the same subject (e.g., Geography T4 and T8 for Flight Navigator).

Further, the topics may be weighted. They may be weighted relatively, with each topic being, for example, 20% more important than the next topic. They may be weighted absolutely, with a topic comprising, e.g., 40% of a particular career and another topic comprising 25%, and so forth. Instead, the weightings may all be equal, e.g., if a career is composed of five topics, they may each count one fifth.

The method 200 comprises determining (at block 206) by the grading module 116 a grade associated with each of the topics. Much of the data to enable this might already be available; however, grading data is traditionally only used to provide a globular grade for a given subject (e.g., 80% or A for English) as a way to gauge a student's skills. Even though final annual grades may be calculated from quarterly grades, which in turn may be determined by weekly class tests, annual grades by themselves may be a naive reflection of a student's true skill-set.

Many existing works describe approaches for collecting academic performance data at various granularities/resolutions—from atomic-level data from video, IOT (Internet Of Things) sensors, GPS (Global Positioning System), and audio up to the scale of social media data, subject-level grades, etc. and distilling these into some measure of a student's skills and capabilities (e.g. US20150140526, US20180068579, CN104572989A). The grading module 116 may be configured to implement one or more of these approaches and may also receive manually inputted grading data from an administrator.

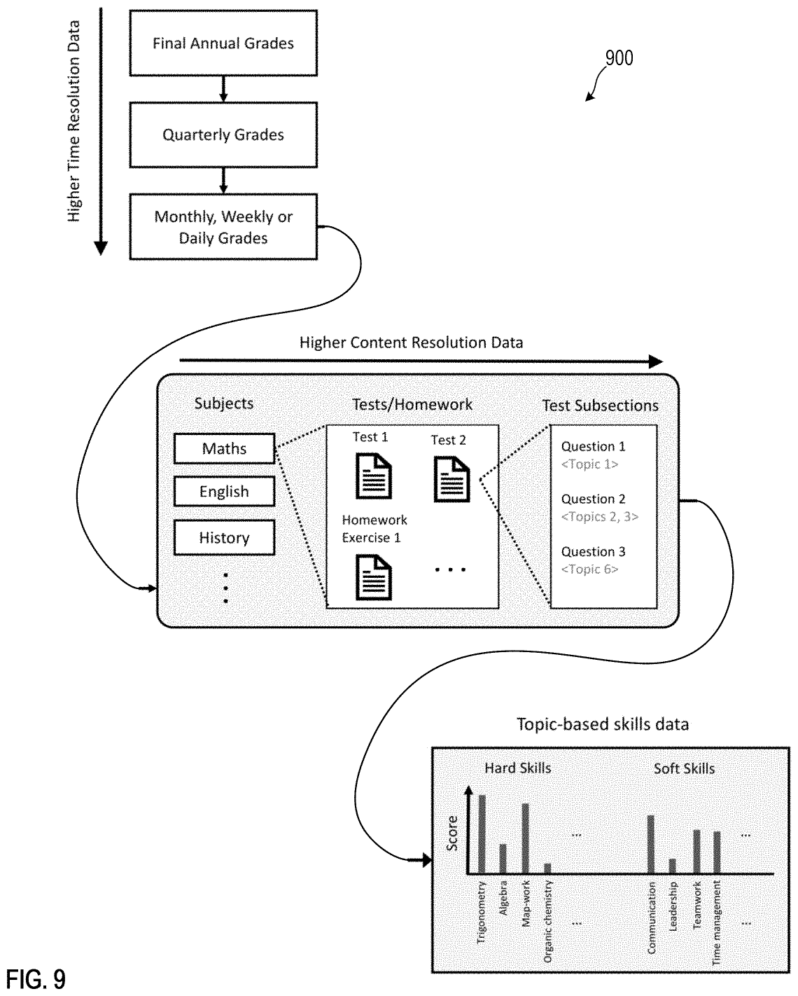

FIG. 9 illustrates a flow diagram 900 of a grading data collection approach which may be used in the present example embodiment. The flow diagram 900 shows a hierarchy of resolutions at which academic performance data exists at school. Resolution of data with respect to time corresponds to going from final yearly grades to quarterly grades and finally down to weekly or daily marks from class tests or homework exercises. Across content, data resolution ranges from overall marks per subject to individual tests/homework exercises down to sections or questions that make up a test/homework exercise.

In accordance with the example embodiment, academic performance data may be considered at the highest available resolution in order to obtain competency scores for topic-based skills. By processing academic performance data of this nature, where individual questions are linked to specific topics, a measure of a student's topic-based skills may be calculated or obtained. The notion of topic-based skills will reflect on very specific categories of hard-skills. However, certain subjects also contain aspects from which soft skills like communication can be inferred.

The method 200 comprises calculating (at block 208), by the prediction module 118, a degree of match for each career option for the student, the degree of match being based on each topic which comprises the career option weighted according to the grade associated therewith. For example, with reference to column one of chart 800, the career Flight Navigator may comprise four topics at associated weightings, namely Math T4 at 40%, Geography T8 at 30%, Geography T4 at 20%, and Science T2 at 10% (to assign arbitrary numerical weightings to the topics). If a student had respective grades of 80%, 70%, 75%, and 60% for the topics, the degree of match of that career to the student may be calculated as follows:

80%*0.4+70%*0.3+75%*0.2+60%*0.1=74%

which may be considered as a relatively good, but not excellent, match.

Topic-based skills may provide an accurate gauge of a student's abilities and an indication of their interests. Accordingly, considering the proposed topic-based method 200 where academic performance is measured at a specific granularity where information is grouped into coherent and logical topics, as a metric for comparison, matching, provisioning advice and guidance in the context of a career recommender/optimizer system, is believed to be unique and novel and may yield superior results compared to existing approaches.

The method 200 may be developed to incorporate facets outside of purely academic subjects. For a comprehensive view of a student's skills, abilities and interests, the method 200 and computer system 100 may be configured to augment the topic-based skills data with meta data from various other sources. Such access may allow for thorough comparison and matching of a student to a very broad range of possible careers.

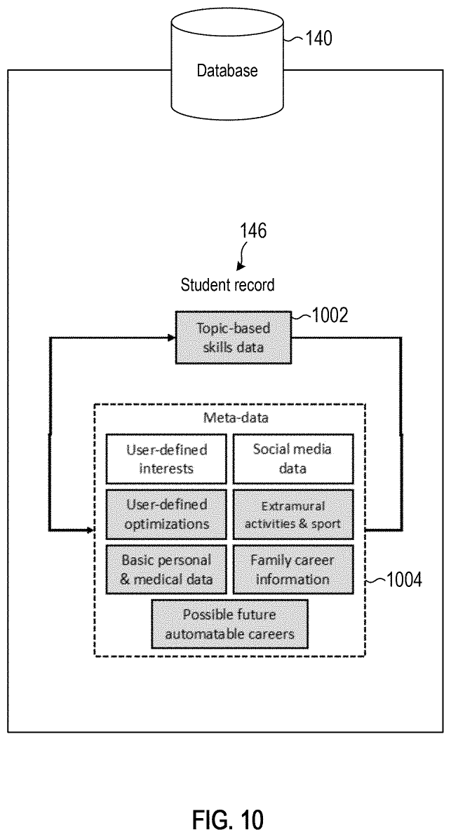

FIG. 10 illustrates an expanded view of the student record 146 stored on the database 140. In addition to topic-based data 1002 (described above), the user record 146 comprises additional information 1004 such as user-defined interests, social media data, user-defined optimizations, extramural activities, basic personal and medical data, family career information, and possible future automatable careers (although this last piece of information may instead be stored as career classification data 144 independent of the student record 146.

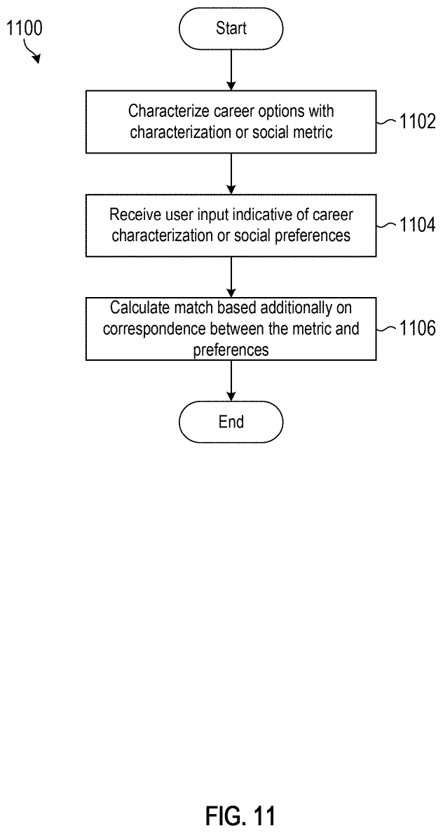

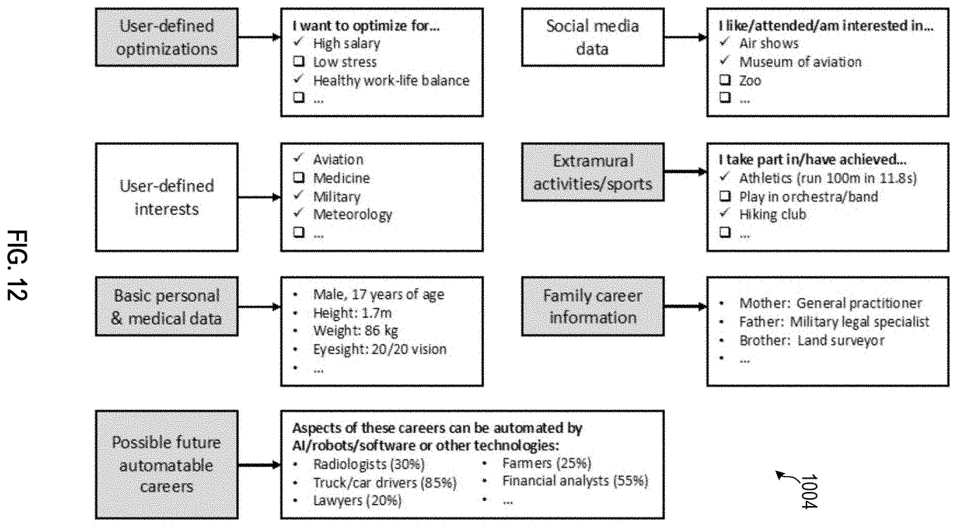

FIG. 11 illustrates a flow diagram 1100 of further features of the method 200 of FIG. 2, and ties in with FIG. 10. Accordingly, the method 1100 may comprise receiving (at block 1104) a user input, e.g., a student input, indicative of a characterization metric such as salary, low stress, work-life balance, etc. which he/she wants to optimize for in a future career. Each career may be pre-populated (at block 1102) with characterization metrics, e.g., is the career stressful, high-earning, etc. The prediction module 118 is configured to calculate or revise (at block 1106) the degree of match, based additionally on a degree of correspondence between the characterization metric (as associated with each career) and the career characterization preferences (as inputted by the student). The computer system 200 may provide a user interface, e.g., a web site, via which the student may supply their input.

This principle may also be applied to social media data. Again referring to the method 1100, each career option may be associated or characterized (at block 1102) with at least one social metric. The student may provide social data by linking or plugging-in or providing access to one or more of their social media profiles (e.g., Facebook™, Instagram™, Twitter™, etc.). The computer system 100 may be configured to pull (at block 1104) the data from a social media profile and store it, at least temporarily, in the student record 146. The prediction module 118 may be configured to calculate (at block 1106) the degree of match, based additionally a degree of correspondence between the social metric (as associated with each career) and the social data (as pulled from a social media profile).

In providing recommendations, advice and guidance, the computer system 100 may also take into account careers/occupations that might become partially or fully automated (and therefore redundant) in the future due to advances in technology (AI, robotics, software, etc.), by mitigating recommendations of such careers or raising awareness to the user. The career classification module 114 may interrogate pre-programmed obsolescence data or may be configured to perform automatic searches and calculate obsolescence risks. The prediction module 118 may accordingly be configured to revise (e.g., lower) a degree of match of the career if that career is at a risk of becoming obsolete or automated, or at least to provide the student with an obsolescence warning.

FIG. 12 illustrates further amplified additional information 1104 which may form part of the student record 146 including many non-academic or non-subject details which may prove useful in providing more holistic recommendations or a more balanced picture. This may be realized by augmenting the topic-based skills data 1002 with meta-data 1004 from different sources. FIG. 12 expands on FIG. 10 by giving examples of the kind of input that can be collected under each category of the meta-data 1004. Some of these data types are described in more detail below.

Topic-based skills data: Using academic performance data at a granularity where information is grouped in logical and coherent topics is intuitive and novel. Using data of this nature for the purpose of career recommendations, advice and guidance is expected to yield more accurate recommendations that are better tailored for a student's interests and strengths compared to standard aptitude tests, professional career counselors or recommender systems that use subject-level grades as a gauge for a student's skills.

User-defined optimizations: A student can specify what he/she wants to optimize for in a career. For example, to pursue a career that would yield maximum income, a career that has as little stress as possible, a career that has a healthy work-life balance, a career that has very little or a lot of interaction with people, etc. (or any combination of these aspects). Giving the student this ability to optimize for certain preferential metrics can avoid risky career changes in the future, which a person might want to do in order to be in a career that fulfils his/her expectations.

Extramural activities and sports: Information about performance and achievements in activities like music/orchestra, athletics, scouts, debate, etc. can shed more light on additional abilities of the student outside of academia. A student might be very good at athletics, along with good performance in the topic of human anatomy and physiology, certain topics in physics and chemistry, as well as good business acumen. Such a combination of extramural activities and topic-based skills may be ideal for becoming a biokineticist. Participating and excelling in debate, public speaking, English literature, spoken English, political/economic geography, etc. may be ideal for pursuing a career in law.

Basic personal & medical data: By recording basic personal and medical data, the student can be assessed for certain (possibly specialized) occupations. If the student is athletic and very fit, he/she could become a professional athlete or a fitness instructor. If the student also has perfect eyesight, he/she could qualify to become a firefighter. With the right height and weight (in addition to sufficient hard topic-based skills) an airline pilot might become an option. Conversely, if a person suffers from disabilities such as hearing loss/deafness, the computer system 100 may be configured to account for that by providing career advice and guidance and recommendations of careers that do not rely extensively on one's ability to hear, for example careers in computer programming, website developer or accounting.

Family career information: In a similar way in which insurance companies make use of nearby family history when insuring a person for health or personal belongings, the computer system 100 may be configured to take such information into account when providing career recommendations, advice and guidance. If both parents of the student are specialized medical doctors for example, the prediction module 118 of the computer system 200 may be configured to infer that the student has access to a well-established network within the medical field and that the student's family would likely be able to afford sending him/her to university or to receive training that might be more expensive (like training for an airline pilot). Alternatively, if the parents of a student are not in high-paying occupations, other possible careers that require more affordable training can be considered. In the latter case, the computer system 100 may also recommend applying for scholarships if necessary.

Possible future automatable careers: With the world becoming more and more governed by technologies like AI (Artificial Intelligence), robotics, software etc., many careers run the risk of becoming automated to some extent or even completely redundant in some cases. By accessing data (via a database or online updates) related to automatable careers, the computer system 200 may account for such risk by raising awareness to the user or lowering a degree of match of such careers. This can be done by showing how much a certain career/occupation is already being automated as a percentage between 0% and 100%, and to give an estimate of how this percentage score can change within 5, 10, 15, etc. years. By incorporating such functionality into the computer system 100, the student may be able to make a more informed decision to invest in skills that will have long-lasting value.

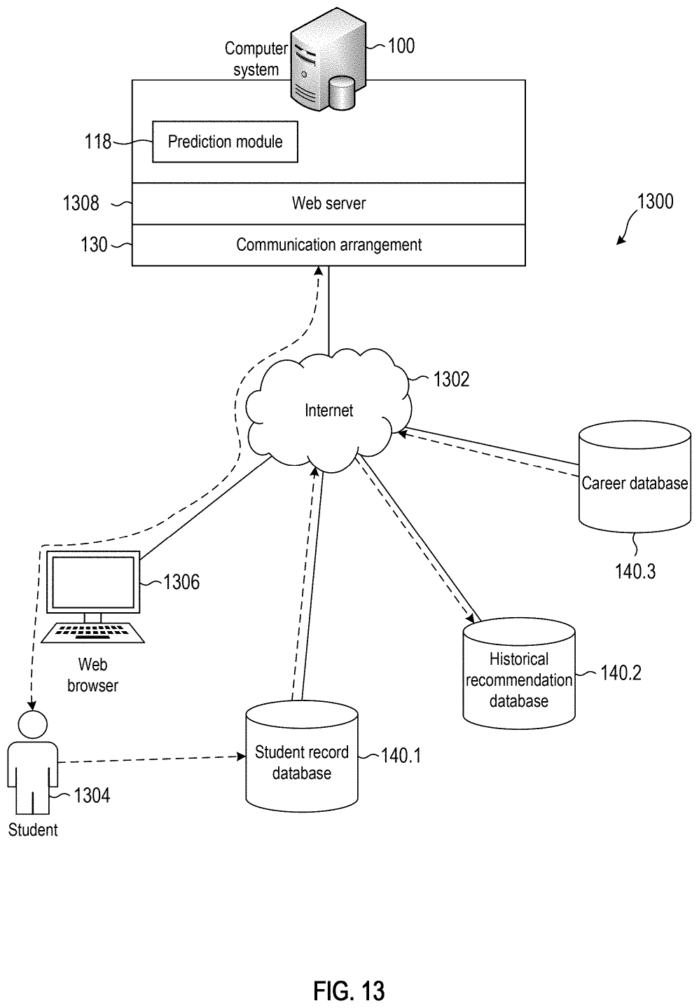

FIG. 13 shows a network topology 1300 within which the computer system 200 may be configured to operate. The computer system 200 is communicatively coupled to a telecommunications network in the form of the internet 1302 via its communication arrangement 130 (e.g., a network interface). The student 1304 will have access to their “topic-based skills profile” via an online interface which they may access via their web browser 1306 (e.g., provided by a computing device) which interfaces with a web server 1308 provided by the computer system 200.

This online interface may be connected to the prediction module 118 which acts as the “brain” or primary calculation engine of the computer system 100 and is responsible for all of the necessary comparisons, analysis and calculations. The prediction module 118 has access to different data streams, like a student information database 1401.1, which characterizes each student. The prediction module 118 also has access to a comprehensive database 140.3 consisting of all possible careers and detailed information about each, which can include all of the topic-based skills required to succeed in this occupation (ranked/scored by importance), salary information, how demanding the work is in terms of time or stress, how much interaction with people is required, particular soft skills that may be required, etc. By connecting to the internet 1302, the prediction module 118 can access the career database 140.3 or monitor information related to careers that can currently/in the future be partially/fully automated by technologies like AI, robots, software, etc. In FIG. 13, the databases 140.1-140.3 have been illustrated as separate, but they may be integrated as in FIG. 1.

The prediction module 118 is configured to give information, recommendations, advice or guidance on, among other things, the following aspects via the online graphical interface:
Careers that are most suitable given a user's current information;
Probability of succeeding in the recommended and/or preferred career;
Topic-based skills that need improvement for increasing success in a user's intended and/or recommended career(s);
Choosing subjects at school;
Attending university after school;
Doing an internship after school or university (and recommendations of suitable internship positions and companies);
Starting a career after school; and/or
Information/warnings of possible careers that can be automated now or might be automated in the future (and the amount of automation).

All output from the prediction module 118 may be stored in a recommendation database 140.2 for historical reference. A student 1304 can then monitor his/her topic-based skills development in real time. Using career-stage feedback from the student 1304 as a reward signal, the computer system 100 may employ a reinforcement learning approach whereby positive career-stage feedback results in positive reinforcement of the recommendations, advice and guidance given earlier. Conversely, negative feedback may require adjustments to the earlier output given by the computer system 100.

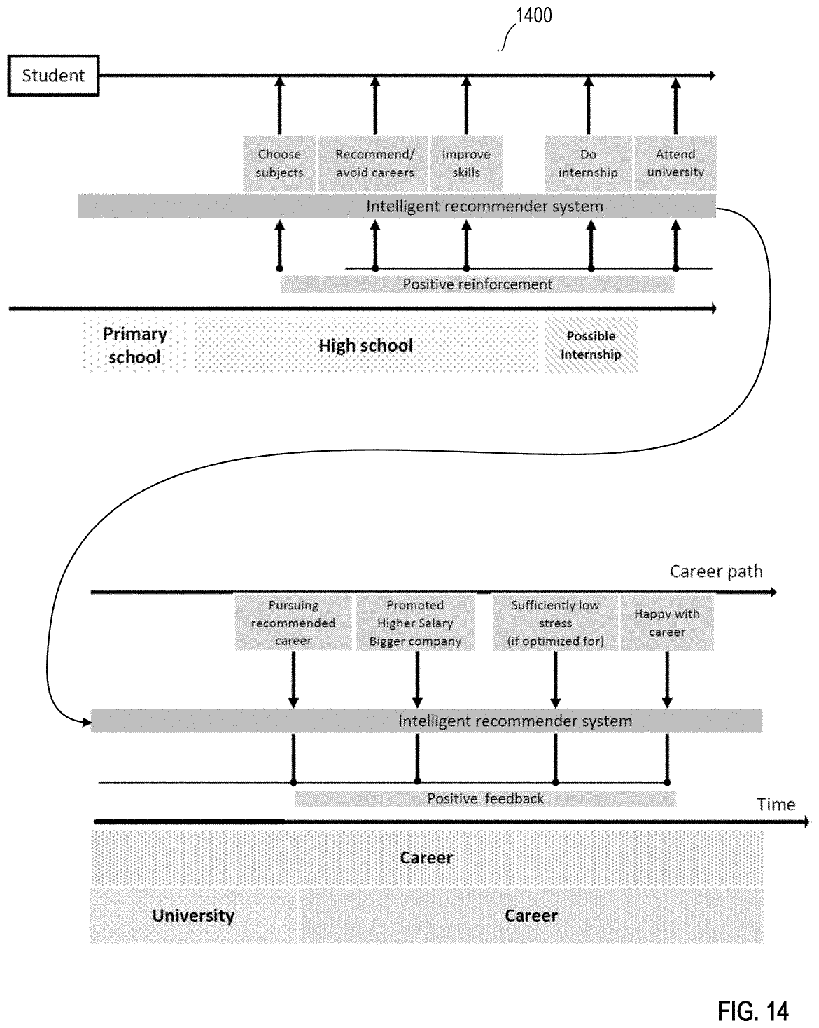

FIG. 14 shows a functional diagram 1400 illustrating a self-correcting reinforcement-learning approach of the computer system 100 and method 200. Throughout high school, the student or user may receive output from the computer system 100 in the form of recommendations, advice and guidance. At career-stage, the computer system 100 can receive feedback from the same user. This feedback can consist of whether the user did indeed pursue any of the recommended careers, has he/she been promoted in this career, does the career meet the user's expectations with regard to the optimization metrics (salary, stress, work-life balance, people interaction, etc.), is the user generally satisfied with the career. Positive feedback would result in positive reinforcement of the output given by the system at an earlier stage, while negative feedback would prompt the system to adjust its output. Even though these are sparse rewards for an RL system, the initial recommendations may already be very accurate by virtue of the quality of the data being used.

The following may be considered a more tangible (but arbitrary) example of the use of the computer system 100.

Ben, a high-school student, has the following subjects: Math, Science, Biology, Geography, Technical drawing, and English. For a career, Ben has an interest in becoming a radiologist, but his other big interest and hobby is that of aviation and to become a pilot, which he is very passionate about. Throughout high-school, Ben scores exceptionally high marks in geometry and trigonometry, but not so much in algebra and calculus, leading to a low overall average grade for math. Ben is also good in doing map-work and finds meteorology very interesting, but he doesn't find other aspects of geography as interesting, resulting in a below-average final grade for geography.

Similarly, for Science, where Ben is very good in physics, especially vector calculations, forces and equations of motion, but he has no interest in chemistry. For biology, ben scores average marks and finds human anatomy quite interesting. For English, he is very good at report writing, spoken English and communicating concepts to an audience, but scores below-average in drama and literature-related topics like poetry and prose. Ben finds technical drawing interesting and does quite well in all topics that make up this subject.

At the end of his high-school career, Ben thinks of enrolling to university to become a radiologist seeing that he finds the human anatomy interesting and thinks that a radiologist career is a good option, since his father is a radiologist. If Ben uses the present system 100, it may make Ben aware that certain aspects of the work of a radiologist can be automated by AI. Since Ben was not aware of this before, he may reconsider and try out for a pilot. The present system 100 may determine that Ben has a strong interest in aviation (from social media posts and likes and from his manually defined interest entered into the system). He also has perfect eyesight, and the right height, weight and fitness for becoming a pilot. He also has strong leadership traits from being a scout-leader throughout high-school. Utilizing the novel approach provided by the method 200 of considering competency in different topics that make up subjects, the computer system 100 can pick up on Ben's stronger topic-based skills, all of which are key to becoming a pilot. However, he falls short on other topic-based skills that are needed for studying and training to successfully become a pilot (which could have been addressed by using advice on skills improvements from the system throughout high-school). The computer system 100 also has data indicating that pilot training is very expensive and that his mother is a stay-at-home mother, so Ben likely doesn't have access to sufficient funding for pilot training.

However, the computer system 100 determines that Ben's topic-based skills are a very good match with the topic-based skills required to become a flight navigator. Ben's career optimization metrics specifies that he does not mind a career with an unfavorable work-life balance and he didn't optimize for obtaining as much income as possible. Everything considered, the most ideal occupation for Ben may be a flight navigator.

Existing career recommender systems or even professional career counselors will generally only make use of final subject-level grades in addition to results from standard aptitude tests. In Ben's case the advice/outcome from such would in all likelihood yield career suggestions that are far removed from unique and specific careers in the airline industry, for example. The computer system 100 and the topic-based skills approach of the method 200 may serve as a more accurate and logical approach for giving career recommendations, advice and guidance.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions. The term “component” as used herein may refer to a module.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method for providing career options, the method comprising:
provisioning, by an academic classification module, each of a plurality of academic subjects into a plurality of topics;
provisioning, by a career classification module, each of a plurality of career options as comprising a plurality of topics;
determining, by a grading module, for a student, a grade associated with each topic for each subject; and
calculating, by a prediction module, a degree of match for each career option for the student, the degree of match based on each topic which comprises the career option weighted according to the grade associated therewith.

2. The method according to claim 1, further comprising:
providing, by the prediction module, at least one recommended career option based on the degree of match.

3. The method according to claim 1, wherein:
each of the plurality of topics comprising each career option has a significance weighting associated therewith; and
the method comprises calculating, by the prediction module, the degree of match for each career option based on both the grade associated with each topic and the significance weighting associated with each topic.

4. The method according to claim 1, further comprising:
characterizing, by the career classification module, each career option with at least one characterization metric;
receiving a user input from the student indicative of career characterization preferences; and
calculating, by the prediction module, the degree of match for each career option based additionally on a degree of correspondence between the characterization metric and the career characterization preferences.

5. The method according to claim 1, further comprising:
characterizing, by the career classification module, each career option with at least one social metric;
receiving an input indicative of social preferences of the student; and
calculating, by the prediction module, the degree of match for each career option based additionally on a degree of correspondence between the social metric and the social preferences.

6. The method according to claim 1, further comprising:
characterizing, by the career classification module, each career option with at least one metric related to basic personal and medical data and/or immediate family career information;
receiving an input indicative of basic personal and medical data and/or immediate family career information of the student; and
calculating, by the prediction module, the degree of match for each career option based additionally on a degree of correspondence between basic personal and medical data and/or immediate family career information.

7. The method according to claim 1, further comprising:
classifying, by the career classification module, a degree of obsolescence risk which faces each career option; and
indicating, by the prediction module, the degree of obsolescence risk which faces each career option.

8. The method according to claim 7, further comprising revising, by the prediction module, the degree of match for each career option based on the degree of obsolescence risk.

9. The method according to claim 1, further comprising:
receiving, from the student, data indicative of a chosen career;
comparing, by the prediction module, the chosen career against the career options; and
updating, by the career classification module, the career options based on the comparison with the data indicative of the chosen career.

10. A computer system for providing career options, the computer system comprising:
a computer processor; and
a computer readable storage medium having stored thereon program instructions executable by the computer processor to direct the operation of the processor, wherein the computer processor, when executing the program instructions, comprises:
an academic classification module configured to provision each of a plurality of academic subjects into a plurality of topics;
a career classification module configured to provision each of a plurality of career options as comprising a plurality of topics;
a grading module configured to determine, for a student, a grade associated with each topic for each subject; and
a prediction module configured to calculate a degree of match for each career option for the student, the degree of match based on each topic which comprises the career option weighted according to the grade associated therewith.

11. The computer system according to claim 10, wherein the prediction module is configured to provide at least one recommended career option based on the degree of match.

12. The computer system according to claim 10, wherein:
each of the plurality of topics comprising each career option has a significance weighting associated therewith; and
the prediction module is configured to calculate the degree of match for each career option based on both the grade associated with each topic and the significance weighting associated with each topic.

13. The computer system according to claim 10, wherein:
the career classification module is configured to characterize each career option with at least one characterization metric; and
the prediction module is configured to calculate the degree of match for each career option based additionally on a degree of correspondence between the characterization metric and career characterization preferences indicated by a user input from the student.

14. The computer system according to claim 10, wherein:
the career classification module is configured to characterize each career option with at least one social metric; and
the prediction module is configured to calculate the degree of match for each career option based additionally on a degree of correspondence between the social metric and social preferences of the student.

15. The computer system according to claim 10, wherein:
the career classification module is configured to characterize each career option with at least one metric related to basic personal and medical data and/or immediate family career information; and
the prediction module is configured to calculate the degree of match for each career option based additionally on a degree of correspondence between the metric related to basic personal and medical data and/or immediate family career information and basic personal and medical data and/or immediate family career information of the student.

16. The computer system according to claim 10, wherein:
the career classification module is configured to classify a degree of obsolescence risk which faces each career option; and
the prediction module is configured to indicate the degree of obsolescence risk which faces each career option.

17. The computer system according to claim 10, wherein the prediction module is configured to revive the degree of match for each career option based on the degree of obsolescence risk.

18. The computer system according to claim 10, wherein:
the prediction module is configured to compare data indicative of a chosen career of the student with career options; and
the career classification module is configured to update the career options based on the comparison with the data indicative of the chosen career.

19. A computer program product for providing career options, the computer program product comprising:
a computer-readable medium having stored thereon:
first program instructions executable by a computer processor to cause the computer processor to provision each of a plurality of academic subjects into a plurality of topics;
second program instructions executable by a computer processor to cause the computer processor to provision each of a plurality of career options as comprising a plurality of topics;
third program instructions executable by a computer processor to cause the computer processor to determine, for a student, a grade associated with each topic for each subject; and
fourth program instructions executable by a computer processor to cause the computer processor to calculate a degree of match for each career option for the student, the degree of match based on each topic which comprises the career option weighted according to the grade associated therewith.
